(19) United States
(12) Patent Application Publication
(10) Pub. No.: US 2002/0113891 A1
(43) Pub. Date: Aug. 22, 2002

(54) Multi-frequency video encoder for high resolution support

(75) Inventor: Benjamin E. Felts III, Cardiff, CA (US)

Correspondence Address: FARJAMI & FARJAMI LLP, 16148 Sand Canyon, Irvine, CA, 92618, US

(73) Assignee: Conexant Systems, Inc.

(21) Appl. No.: 09/777,250

(22) Filed: Feb. 5, 2001

(51) Int. Cl. H04N 7/01; H04N 11/20; H04N 9/74

(52) U.S. Cl. 348/446; 348/581; 348/458

(57) ABSTRACT

One disclosed embodiment comprises a vertical scaler receiving a first number of video lines at a first frequency. The vertical scaler outputs a second number of video lines at the first frequency. A FIFO has as an input from the vertical scaler the second number of video lines at the first frequency. The FIFO outputs the second number of video lines at a second frequency. Another disclosed embodiment further comprises a modulator/timing generator having as an input from the FIFO the second number of video lines at the second frequency. The second number of video lines can be in a first video format. The first video format can be a high resolution video format. The modulator/timing generator converts the second number of video lines in the first video format into a second video format. The second video format can be a low resolution video format.

### BACKGROUND OF THE INVENTION

1. Field of the Invention

The present invention is generally in the field of processing video signals. More specifically, the present invention is in the field of converting higher resolution video formats into lower resolution video formats.

2. Background Art

As a result of the proliferation and utilization of the personal computer (“PC”) in the home, in the workplace, and in the school, there exists an increasing demand for devices that can accurately display the images produced by a PC on a television set. However, there are various problems encountered in the conversion of computer video into television video, for example into National Television Standards Committee (“NTSC”) video.

Computer video comes in various resolutions that are generally classified in the industry under two graphics standards—Video Graphic Array (“VGA”), and Super Video Graphics Array (“SVGA”). The typical resolution for VGA is 640×480, which refers to “frame” that contains 480 lines of pixel data, with each line containing 640 input pixels. A “frame” refers to the actual pixel data that is viewable in a complete image on a computer monitor screen. The area of the computer monitor screen on which the actual pixel data resides is called the active region. The typical resolution for SVGA is 800×600 and higher of data pixels in the active region of the computer screen. On the other hand, NTSC video contains 525 lines of pixel data in a complete image on a TV monitor screen.

As is known in the art, only approximately 483 of those 525 lines of pixel data are in the active region and only approximately 420 of those are visible on the TV monitor screen. Also, for NTSC video, the video image is scanned on the TV monitor in two “fields,” which make up one frame of pixel data. The odd numbered lines are scanned first in an “odd” field, and then the even numbered lines are scanned in an “even” field. This method of scanning is known in the art as “interlaced” scanning. Therefore, each field in NTSC video contains approximately 210 lines of pixel data in the visible active region of the TV monitor screen. The device that takes a VGA computer video image with a resolution of 640×480, for example, and converts it to an NTSC video image for display on a TV monitor is generally known as a video encoder. Video encoders vary greatly in their ability to convert various VGA and SVGA resolutions of computer video into NTSC video, especially in regard to the higher SVGA resolutions, such as 800×600 and 1024×768.

FIG. 1 shows vertical scaler 104 of system 100 receiving input pixel data 102 and providing vertical scaler output 106 to FIFO 108. FIFO (“First In—First Out”) 108 provides FIFO output 110 to modulator/timing module 112. Modulator/timing module 112 provides clock 114 to vertical scaler 104 and also generates output pixel data 116.

System 100 converts pixel data in one video format, such as a VGA video format, and converts the pixel data into another video format, such as an NTSC video format. The operation of system 100 will be explained by converting, for example, pixel data in a VGA video format 640×480 resolution, into pixel data in an NTSC video format. Input pixel data 102 is typically sent to system 100 from a graphics controller, which is not shown in FIG. 1 to preserve simplicity. Input pixel data 102 consists of a full frame of 480 lines of pixel data, with each line of pixel data comprising 640 pixels. Input pixel data 102 is clocked into system 100 by clock 114. In the present example, the frequency of clock 114 is 27 megahertz (“MHz”). Vertical scaler 104 receives 480 lines of pixel data, with each line comprising 640 pixels. In the example of system 100, vertical scaler 104 provides, among other things, a 2.29:1 vertical “scaling” of input pixel data 102. Vertical “scaling” refers to the process whereby the number of lines of pixel data of one video standard, such as VGA 640×480 resolution, is reduced by a certain ratio, such as 2.29:1, to match the number of lines of pixel data required by another video standard, such as NTSC.

Therefore, FIFO 108 receives approximately every other line of pixel data from vertical scaler 104 provided by vertical scaler output 106. The approximately every other line of pixel data at vertical scaler output 106 is written into FIFO 108 at the frequency of clock 114, which is 27 MHz in the present example. In system 100 in FIG. 1, each pixel in a line of pixel data is read out of FIFO 108 at the high to low transition of every other clock cycle at FIFO output 110. Thus, in effect, each pixel in a line of pixel data is read out of FIFO 108 at 13.5 MHz. The line of pixel data is received by modulator/timing module 112 at FIFO output 110.

In modulator/timing module 112, up to the point where the line of pixel data is subject to “2× up-sampling,” the clock rate of the line of pixel data is 13.5 MHz. “2× upsampling” refers to a process whereby the pixel data is sent through an interpolation filter that generates an additional sample that resides mid-way between each pair of samples that are flowing through the interpolation filter. In modulator/timing module 112, after the “2× up-sampling,” clock rate of the line of pixel data is 27 MHz. Modulator/timing module 112 converts the line of pixel data from VGA and SVGA video format to NTSC video format and outputs the line of pixel data in NTSC video format at its output pixel data 116.

The approach described in system 100 in FIG. 1 for converting VGA and SVGA video format pixel data into NTSC video format pixel data works for VGA 640×480 resolution. However, system 100 in FIG. 1 has problems converting SVGA 800×600 resolution and higher resolutions, such as SVGA 1024×768, into NTSC video format pixel data. It is known that the horizontal resolution of the input pixel data and the portion of the horizontal active region that it should cover will determine the output clocking frequency. That clocking frequency will determine the number of clocks per field. In the VGA video format, the minimum total number of input pixels per field is less than the number of clocks per field. Accordingly, the entire video encoder (i.e. system 100) can be clocked at the output clocking frequency. However, in the SVGA video format there is a much larger number of input pixels per field in comparison to the VGA format. As such, there are not enough clock cycles to clock in all the data in the active region of the frame for the conversion of SVGA video format 800×600 resolution pixel data, or SVGA video format 1024×768 resolution pixel data, into NTSC video format pixel data.

One approach used in the art by video encoders for converting VGA and SVGA video format pixel data into NTSC video format pixel data is to restrict the input pixel data resolution, and thus forgo support for higher resolutions, such as SVGA video format 1024×768 resolution.

Yet another approach used in the art by video encoders for converting VGA and SVGA video format pixel data into NTSC video format pixel data is to force the device providing the input pixel data, such as a graphics controller, to scale high resolution pixel data, such as SVGA video format 1024×768 resolution, down to a resolution that is acceptable, such as VGA video format 640×480 resolution. This approach impairs the video quality that a video encoder can produce for a higher resolution, such as SVGA video format 1024×768 resolution.

There is need in the art for properly and efficiently converting video data in a first frequency to video data in a second frequency without loss of video information. There is also need in the art for a solution for properly and efficiently converting high resolution video format having a first frequency, such as VGA and SVGA video formats, into a low resolution video format having a second frequency, such as NTSC or another low resolution video format.

### SUMMARY OF THE INVENTION

The present invention is directed to system and method for high resolution support in video encoding. The present invention discloses a multi-frequency video encoder for properly and efficiently converting video data in a first frequency to video data in a second frequency without loss of video information. The present invention also works properly and efficiently in converting high resolution video format having a first frequency into a low resolution video format having a second frequency.

In one embodiment, the present invention comprises a vertical scaler receiving a first number of video lines at a first frequency. The invention's vertical scaler outputs a second number of video lines at the first frequency. The invention further comprises a FIFO having as an input from the vertical scaler the second number of video lines at the first frequency. The invention's FIFO outputs the second number of video lines at the second frequency.

In one embodiment, the invention further comprises a modulator/timing generator having as an input from the FIFO the second number of video lines at the second frequency. For example, the second number of video lines can be in a first video format. By way of example, the first video format can be a high resolution video format such as VGA or SVGA. The invention's modulator/timing generator converts the second number of video lines in the first video format into a second video format. For example, the second video format can be a low resolution video format such as NTSC, PAL, SECAM, or SCART.

In one embodiment, the invention further comprises a multi-frequency clock generator having as outputs a first clock at the first frequency and a second clock at the second frequency. The first frequency can be either an integer or non-integer ratio of the second frequency. Moreover, the first clock and the second clock can be either synchronous or asynchronous.

As described in the detailed description herein, the multi-frequency video encoder of the present invention achieves a proper and efficient conversion of a high resolution video format having a first frequency, such as VGA and SVGA video formats, into a low resolution video format having a second frequency, such as NTSC or another low resolution video format.

### BRIEF DESCRIPTION OF THE DRAWINGS

FIG. 1 shows an existing system for converting high resolution video format pixel data to low resolution video format pixel data.

FIG. 2 shows an embodiment of the invention's multi-frequency video encoder for converting high resolution video format pixel data to low resolution video format pixel data.

FIG. 3 shows the operation of a FIFO utilized in one embodiment of the invention's multi-frequency video encoder.

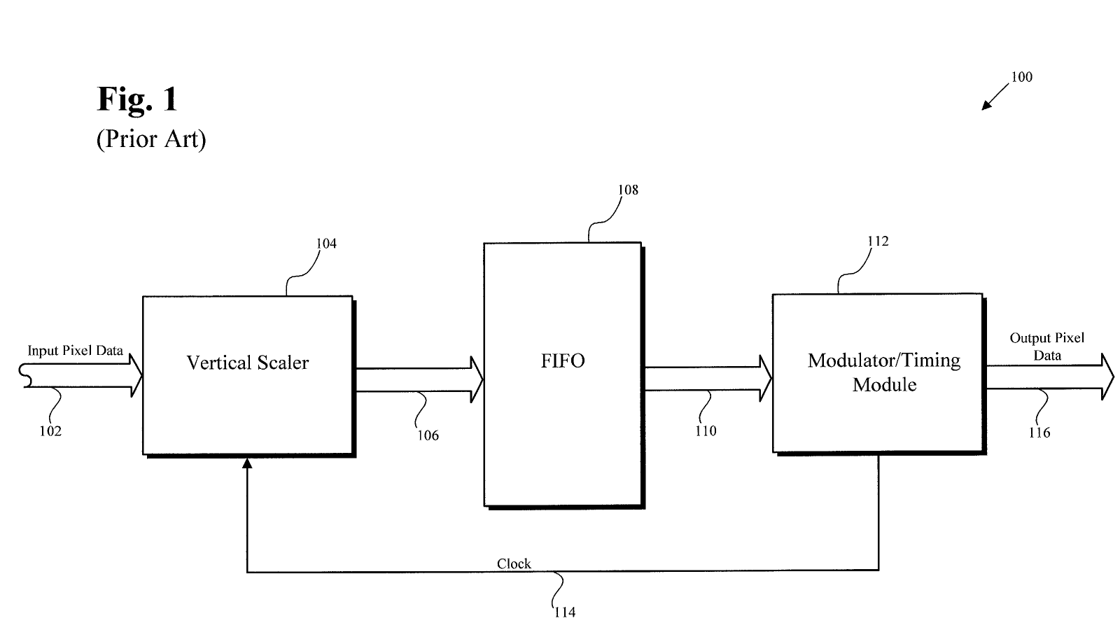

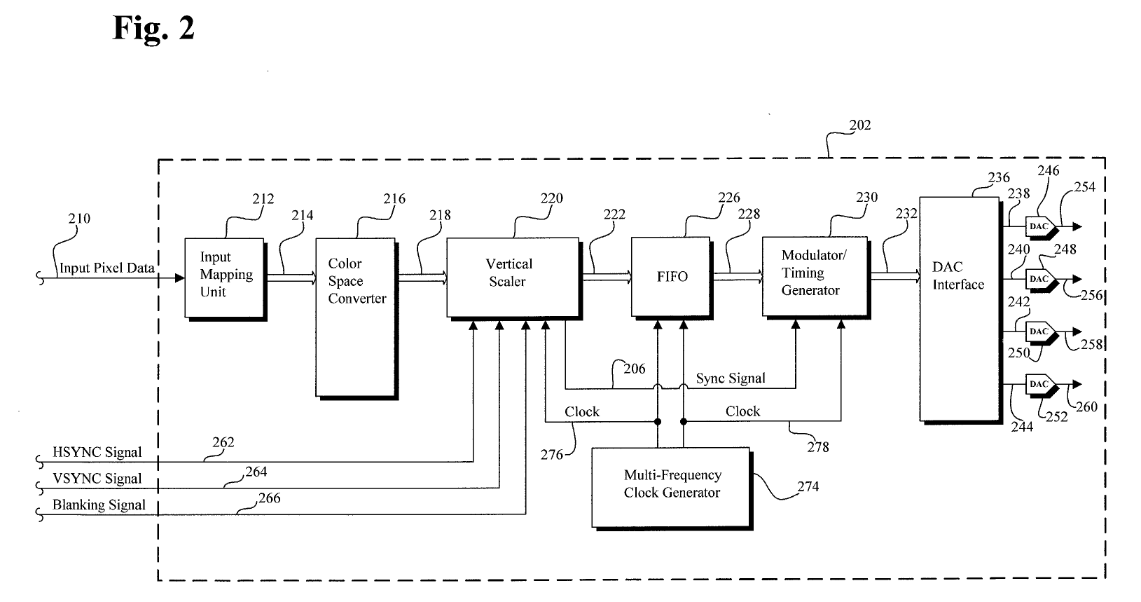

### DETAILED DESCRIPTION OF THE INVENTION

The present invention is directed to a multi-frequency video encoder for high resolution support. The following description contains specific information pertaining to different types of video formats, clock frequencies, and implementations of the invention's multi-frequency video encoder. One skilled in the art will recognize that the present invention may be practiced in a manner different from that specifically discussed in the present application. Moreover, some of the specific details of the invention are not discussed in order not to obscure the invention. The specific details not described in the present application are within the knowledge of a person of ordinary skills in the art.

The drawings in the present application and their accompanying detailed description are directed to merely example embodiments of the invention. To maintain brevity, other embodiments of the invention that use the principles of the present invention are not specifically described in the present application and are not specifically illustrated by the present drawings.

FIG. 2 shows some of the modules of an exemplary embodiment of the present invention's multi-frequency video encoder 202, also referred to simply as video encoder 202. In FIG. 2, input mapping unit 212 receives input pixel data 210 from a source external to video encoder 202, for example from a graphics controller not shown in FIG. 2. Input mapping unit 212 further provides its output 214 to color space converter 216. Color space converter 216 provides its output 218 to vertical scaler 220. Vertical scaler 220 receives horizontal synchronizing signal (“HSYNC”) 262, vertical synchronizing signal (“VSYNC”) 264, and blanking signal 266 from a source external to video encoder 202. Alternatively, the HSYNC, VSYNC, and blanking signals can be generated by vertical scaler 220 for use by video encoder 202 and the external source. Vertical scaler 220 also receives clock 276 from multi-frequency clock generator 274. Vertical scaler 220 provides its pixel data 222 to FIFO 226, and it (i.e. vertical scaler 220) also provides sync signal 206 to modulator/timing generator 230.

FIFO 226 receives clock 276 and clock 278 from multi-frequency clock generator 274. FIFO 226 provides its pixel data 228 and control signal 224 to modulator/timing generator 230. Modulator/timing generator 230 receives clock 278 from multi-frequency clock generator 274 and provides its output 232 to DAC interface 236. DAC interface 236 provides its outputs 238, 240, 242, and 244, respectively, to DACs 246, 248, 250, and 252. DAC outputs 254, 256, 258, and 260 are generated, respectively, by DACs 246, 248, 250, and 252.

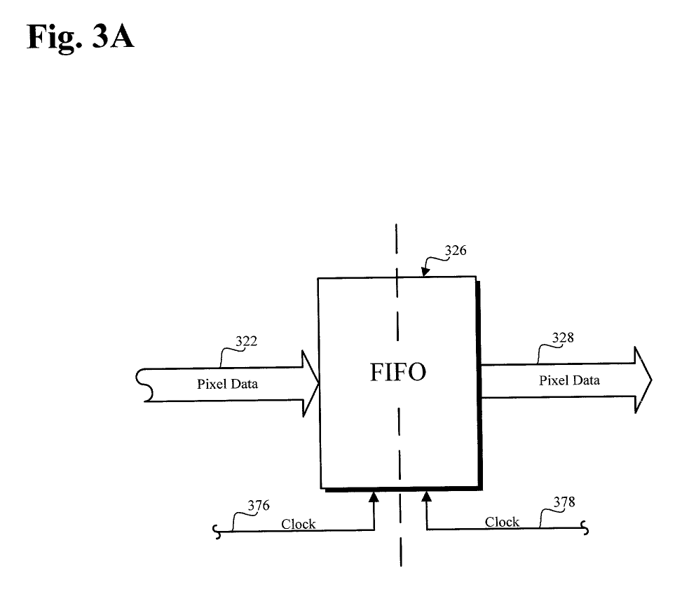

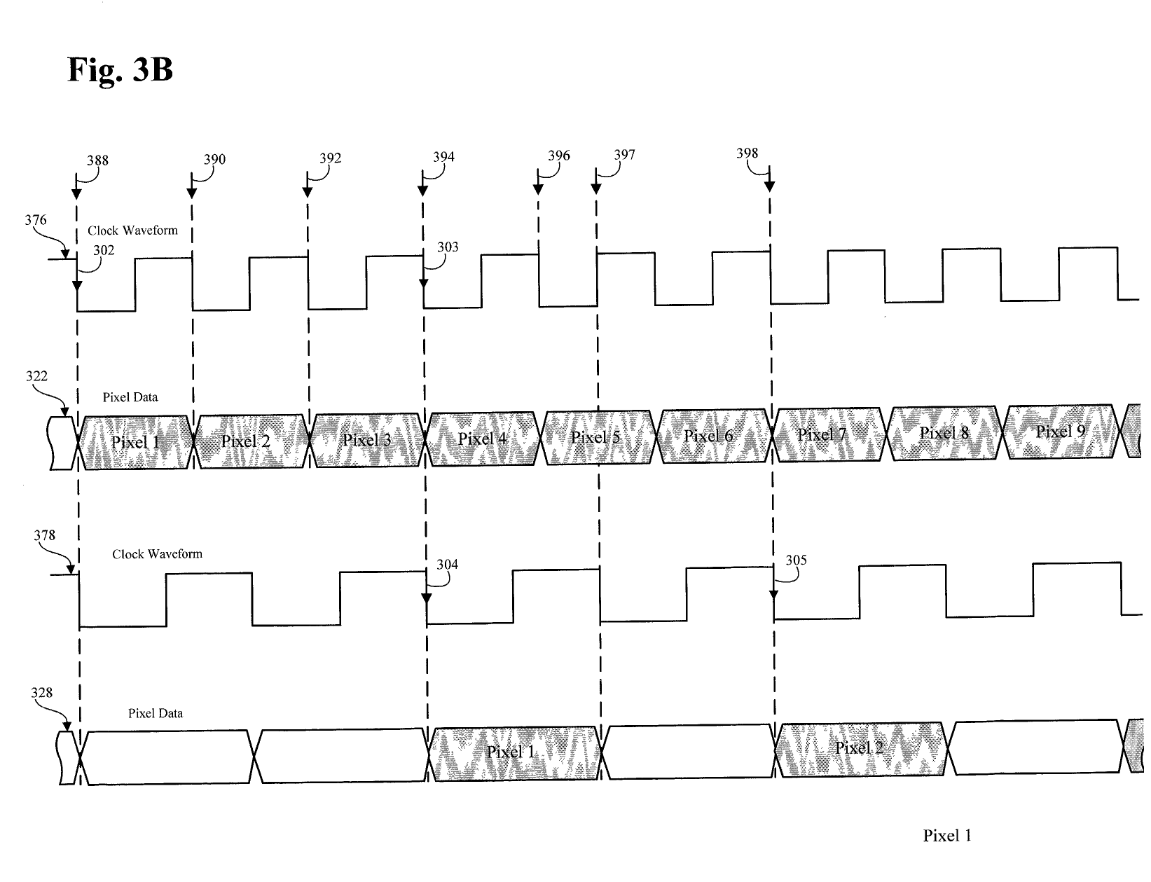

The operation of the exemplary embodiment of the present invention's video encoder 202 will be discussed by referring to FIG. 2 as well as FIGS. 3A and 3B. For the purpose of illustration, the exemplary embodiment of the invention is discussed by referring to the specific example of conversion of SVGA video format 1024×768 resolution pixel data into NTSC video format pixel data. However, it is manifest to persons of ordinary skill in the art that the invention described in the present application can be used for conversion of any high resolution video format to another video format. For example, a high resolution video format such as VGA or SVGA may be converted into a low resolution video format such as NTSC, SCART, PAL (“Phase Alternate Line”), and SECAM (“SEquential Color And Memory”). During operation of the invention's video encoder 202, input mapping unit 212 receives pixel input data 210 from a source external to video encoder 202, for example, from a graphics controller. In the present example of conversion of SVGA video format 1024×768 resolution pixel data into NTSC video format pixel data, pixel input data 210 comprises 768 lines of pixel data, with each line of pixel data further comprising 1024 data pixels. It is noted that in SVGA video format 1024×768 resolution, “1024×768” refers to 768 lines of 1024 data pixels in the “active region” of a SVGA monitor screen. The “active region” refers to the area that is actually visible on the SVGA monitor screen. On the other hand, the NTSC video format has only 525 lines of pixel data. In the present application, each line of pixel data in a given video format is also referred to as a “video line.” Although only approximately 420 of the 525 lines of pixel data in the NTSC video format are in the visible active region of the television monitor, all 525 lines of pixel data, or approximately 262 lines of pixel data per field, must be provided by the present invention's video encoder 202 to the television monitor.

Also, the NTSC video format utilizes interlaced scanning, which refers to the fact that the television monitor scans an odd field of lines first, consisting of the odd numbered lines of pixel data, and then the television monitor scans an even field of lines of pixel data, consisting of the even numbered lines of pixel data. Each field of lines of pixel data is refreshed, or updated on the television screen every 1/60 of a second. The odd and even fields each contain approximately 262 lines of pixel data and together form one frame of pixel data. The SVGA video format, by comparison, utilizes non-interlaced scanning, which refers to the fact that the SVGA monitor scans all 768 lines of pixel data in SVGA 1024×768 resolution at one time. The 768 lines of pixel data collectively refer to a frame of pixel data. The 768 lines of pixel data are refreshed, or updated by the SVGA monitor every 1/60 of a second, or faster, depending on the vertical frequency of the SVGA monitor.

Thus, the conversion of SVGA video format 1024×768 resolution pixel data into NTSC video format pixel data requires the conversion of a frame, or 768 lines of pixel data in SVGA video format into a field, or approximately 210 lines of pixel data in NTSC video format every 1/60 of a second, assuming an SVGA vertical frequency of 60 cycles. Therefore, every 1/60 of a second, a frame of 768 lines of pixel data in SVGA video format will be alternately converted into an odd or an even field of approximately 262 lines of NTSC video format.

Input mapping unit 212 functions as a demultiplexer. As is known in the art, a demultiplexer can function to map or transform serial data into parallel data. Input mapping unit 212 takes input pixel data 210, which is in the form of a digital serial data stream comprising, for example, 768 lines of 1024 data pixels in SVGA video format 1024×768 resolution, and maps or transforms the serial data into parallel data. Input mapping unit 212 provides its output 214 to color space converter 216.

Color space converter 216 converts output 214 of input mapping unit 212 from the “color space” that the data is in, for example from the RGB (“Red, Green, Blue”) color space that the SVGA video format pixel data is in, to a different “color space,” such as the “YIQ” (i.e., Y refers to “luminance,” I refers to “red minus Y,” and Q refers to “blue minus Y”) color space of the NTSC video format. By way of background, a “color space” is a system utilized to specify, create, and visualize color. For example, “RGB” (i.e., red, green, and blue) color space refers to a color space employed by cathode ray tube (“CRT”) displays, where excitation of red, green, and blue emitting phosphors produce various colors when fused. Color space converter 216 provides its output 218 to vertical scaler 220.

Vertical scaler 220 incorporates normal and adaptive filtering technology for “flicker” removal and vertical scaling that allows high quality display of non-interlaced images on an interlaced television monitor. By way of background, television monitors typically have an interlaced display, whereas personal computer (“PC”) monitors have a non-interlaced, or progressive display. Since television screens refresh, or update their images at a slower rate than PC monitors, when images created for PC monitors are shown on an interlaced television, the human eye detects the lower refresh rate, causing computer-rendered images to appear to “flicker.” Vertical scaling is necessary to display an SVGA video format computer image with a resolution of, for example, 1024×768 on a television monitor. The SVGA video format computer image with 1024×768 resolution has 768 horizontal lines of pixel data (or simply lines of pixel data) in the active region of the computer monitor. As explained above, these 768 lines of pixel data must fit in approximately 210 lines of pixel data in the visible active region of the television monitor each 1/60 of a second. Therefore, vertical scaling is necessary to reduce the SVGA video format's 768 lines of pixel data down to approximately 210 lines of pixel data required by the NTSC video format in the active region of the television monitor's screen.

In the present embodiment of the invention's video encoder 202, vertical scaler 220 runs, for example, at the clock frequency of 75 MHz, supplied by clock 276, to scale the 768 lines of pixel data at output 214 down to the required approximately 210 lines of pixel data in each field of the NTSC video format in the active region of the television monitor. In the present embodiment of the invention's video encoder 202, although a clock frequency of 75 MHz is used as an example of the conversion of SVGA video format 1024×768 resolution pixel data into NTSC video format pixel data, other clock frequencies may be used in the conversion of other video formats.

Vertical scaler 220 provides pixel data 222 to FIFO 226. Vertical scaler 220 performs “vertical scaling” which is part of the “overscan compensation” process performed by which the present embodiment of the invention's video encoder 202 converts, for example, 768 lines of pixel data in SVGA video format 1024×768 resolution to the appropriate number of lines of pixel data, for example, in NTSC video format (i.e., approximately 210 lines of pixel data in the visible active region of the television monitor screen). Pixel data 222 consists, for example, of approximately 210 lines of pixel data required for the conversion of SVGA video format 1024×768 resolution pixel data into a field of NTSC video format pixel data. Vertical scaler 220 also provides sync signal 206 to modulator/timing generator 230. Sync signal 206 alerts modulator/timing generator 230 to the start of each frame of pixel data.

Continuing with the discussion of the operation of the present embodiment of the invention, FIFO 226 receives pixel data 222 from vertical scaler 220. A line of pixel data 222 from vertical scaler 220 is clocked into FIFO 226 by clock 276 generated by multi-frequency clock generator 274. A line of pixel data 228 to modulator/timing generator 230 is clocked out of FIFO 226 by clock 278 generated by multi-frequency clock generator 274. According to the present embodiment of the invention, clock 276 and clock 278 generally have two different frequencies. Thus, in a manner known in the art, multi-frequency clock generator 274 generates clocks 276 and 278 having two different frequencies. In general, according to the present embodiment of the invention, the frequencies of clocks 276 and 278 can be of an integer ratio. Alternatively, the frequencies of clocks 276 and 278 can be of a non-integer ratio. As an example of a noninteger ratio, the ratio of the frequencies of clocks 276 and 278 can be 3:2, also referred to as a 3:2 clocking mode. In a 3:2 clocking mode, the ratio of the clock frequencies is 1.5, which is of course not an integer. In fact in the exemplary embodiment of the invention described herein, since clock 276 has a frequency of 75 MHz, and clock 278 has a frequency of 50 MHz, the ratio of clock 276 to clock 278 is 75 MHz/50 MHz, i.e., 3:2, which is a non-integer ratio.

FIFO 226 provides pixel data 228 to modulator/timing generator 230. The operation of FIFO 226 will be explained in more detail in relation to FIGS. 3A and 3B. Modulator/timing generator 230 is utilized to reformat pixel data 228 received from FIFO 226, into another format. For example, pixel data 228 in SVGA video format 1024×768 could be reformatted into NTSC video format pixel data in modulator/timing generator 230. Modulator/timing generator 230 also generates timing that is used to synchronize pixel data 228 so that pixel data 228 can be properly utilized by modulator/timing generator 230. In one implementation, the timing generator in modulator/timing generator 230 also functions to generate the signals for proper encoding pixel data 228 in SVGA video format into, for example, NTSC video format. Modulator/timing generator 230 operates at the frequency of clock 278, for example, at 50 MHz in the present embodiment of the invention's video encoder 202. Modulator/timing generator 230 provides its output 232 to the invention's DAC interface 236.

DAC interface 236 digitally adds or combines the format data information with the appropriate level information for that format, and provides this information to an external device, such as a television monitor. DAC interface 236 provides outputs 238, 240, 242, and 244, respectively, to DACs 246, 248, 250, and 252. DACs 246, 248, 250, and 252 convert the digital data they receive at outputs 238, 240, 242, and 244, respectively, into analog data.

Referring to FIGS. 3A and 3B, the operation of the present embodiment's FIFO 326, corresponding to FIFO 226 in FIG. 2, is now discussed in more detail. FIFO 326 receives clock 376, corresponding to clock 276 in FIG. 2. Clock waveform 376 in FIG. 3B corresponds to clock 376 in FIG. 3A. Pixel data waveform 322 in FIG. 3B corresponds to pixel data 322 in FIG. 3A which in turn corresponds to pixel data 222 in FIG. 2. Clock waveform 378 in FIG. 3B corresponds to clock 378 in FIG. 3A. Pixel data waveform 328 in FIG. 3B corresponds to pixel data 328 in FIG. 3A which in turn corresponds to pixel data 228 in FIG. 2.

[NOTE: The line is written into the FIFO one pixel per clock on consecutive clocks (e.g. 1024 consecutive clocks), then about two lines (e.g. 2.66 lines) are not clocked into the FIFO. This line is read out of the FIFO on every other clock. So one line is “burst” into the FIFO, and then gradually read out. The next section needs to be rewritten to reflect this (i.e. the data is not clocked in on every third clock).]; Q: What is clocked out of FIFO, is it P1, P3, P5, etc . . . or P1, P4, P7, etc . . .

At time 388, which corresponds to the beginning of a first clock cycle in clock waveform 376, one pixel in a line of pixel data, shown as “Pixel 1” in pixel data waveform 322, is written into FIFO 326. More precisely, the pixel written into FIFO 326 is written into FIFO 326 upon a falling edge of clock waveform 376. In the present example, “Pixel 1” in a line of pixel data is written into FIFO 326 on edge 302 which is the falling edge occurring at time 388 in clock waveform 376.

At time 390, which corresponds to the beginning of a second clock cycle in clock waveform 376, “Pixel 2” in the line of pixel data is written into FIFO 326. Similarly, at time 392, which corresponds to the beginning of a third clock cycle of clock waveform 376, “Pixel 3” in the line of pixel data is written into FIFO 326. . More precisely, each pixel in the line of pixel data written into FIFO 326 is written into FIFO 326 upon a falling edge of clock waveform 376. In the present example, “Pixel 4” of the line of pixel data is written into FIFO 326 on edge 303 which is the falling edge occurring at time 394 in clock waveform 376. Thus, in the present embodiment's invention, each pixel (i.e., “Pixel 1,” “Pixel 2,” “Pixel 3,” etc.) in the line of pixel data is written into FIFO 326 on the falling edge of every clock cycle of clock waveform 376 in FIG. 3B. After the last pixel in the line of pixel data is written into FIFO 326, the next approximately 2.66 lines of pixel data are not written into FIFO 326.

As shown in FIG. 3B, between time 388 and time 394, there are two clock cycles in clock waveform 378. At time 394, a pixel, for example, shown as “Pixel 1” in pixel data 328 in FIG. 3B, is read out of FIFO 326. More precisely, each pixel in the line of pixel data read out of FIFO 326 is read out upon a falling edge of clock waveform 378. In the present example, “Pixel 1” of the line of pixel data is read out of FIFO 326 on edge 304 which is the falling edge occurring at time 394 in clock waveform 378.

As further shown in FIG. 3B, between time 394 and time 398, there are two clock cycles in clock waveform 378. At time 398, for example, “Pixel 2” of the line of pixel data 328 is read out of FIFO 326 More precisely, the pixels in the line of pixel data read out of FIFO 326 are read out upon a falling edge of clock waveform 378, which in the present example is falling edge 305 occurring at time 398 in clock waveform 378. Thus, in the present embodiment of the invention, the pixels (i.e., “Pixel 1,” “Pixel 2,” etc.) in the line of pixel data read out of FIFO 326 are read out of FIFO 326 upon the falling edge of every second clock cycle of clock waveform 378.

In conclusion, as explained above, the pixels in a line of pixel data are written into FIFO 326 upon the falling edge of every clock cycle of clock waveform 376. The same pixels in the line of pixel data are read out of FIFO 326 upon the falling edge of every second clock cycle of clock waveform 378.

As stated above, in the present exemplary embodiment of the invention, clock 376 operates at a frequency of 75 MHz and clock 378 operates at a frequency of 50 MHz. As such, the frequencies of clocks 376 and 378 are in a ratio of 3:2, also referred to as 3:2 clocking mode. Also, in FIG. 3B clock waveforms 376 and 378 are shown as synchronous clocks, i.e. as clocks that operate in phase with each other. However, clocks 376 and 378 may also operate in an “asynchronous mode.” For example, pixel data can be in the process of being written into FIFO 326 at the same time that pixel data is just starting to be read out of FIFO 326. In other words, pixel data does not have to be read out of FIFO 326 in synchronization with pixel data that is written into FIFO 326.

As stated above, in the present exemplary embodiment, with clock 376 operating at 75 MHz, the pixels in a line of pixel data are written into FIFO 326 upon the falling edge of every clock cycle of clock 376. After the pixels in the line of pixel data are written into FIFO 326, no pixels are written into FIFO 326 for the next approximately 2.66 lines of pixel data. Also, with clock 378 operating at 50 MHz, the pixels in the line of pixel data are read out of FIFO 326 upon the falling edge of every other clock cycle of clock 378. In other words, the pixels in the line of pixel data are read out of FIFO 326 in the equivalent amount of time it takes to write the line of pixel data into FIFO 326, plus the additional amount of time it would have taken to write into FIFO 326 2.66 lines of pixel data. Therefore, in the present embodiment's video encoder 202, there are approximately 2.66 lines of clock cycles out of every group of approximately 3.66 lines of clock cycles of clock 376 in which no data is written into FIFO 326. In effect, these approximately 2.66 lines of clock cycles provide the additional clock cycles necessary to input and scale high resolution video format pixel data, such as SVGA 1024×768 resolution. Thus, the invention's video encoder 202 is performing “horizontal scaling” of the pixel data at input pixel data 210 (FIG. 2) by operating clock 378 at a higher frequency (e.g., 50 MHz) than is typical for a video encoder (e.g., 27 MHz), and operating clock 376 at an even higher frequency (e.g., 75 MHz) to be able to input all the active pixel data required. “Horizontal scaling” refers to the process whereby a line of pixel data in one video format, i.e., SVGA 1024×768 resolution, can be converted to another video format, e.g. NTSC video format, and made to “fit” in the active region of the monitor in that video format.

For example, SVGA video format 1024×768 resolution pixel data that is to be outputted as NTSC video format pixel data has over three lines of input pixels for each line of output pixels. That is, for 768 active lines of pixel data in SVGA video format, there are only 210 visible active lines of pixel data in NTSC video format, which results in a ratio of 3.66 lines of input to 1.0 line of output. Since the visible horizontal active region of a line of pixel data in NTSC video format is about 66% of the total line, even with 2× up-sampling there would only be (1024×2)/0.66=3103 output clock cycles per line of pixel data in NTSC video format. However, this is much fewer than the approximately 3748 input clock cycles required for the 3.66 lines of input pixel data (i.e., 3.66×1024=3747.84 input clock cycles).

The present embodiment of the invention provides clock 276 to clock pixel data 218 into vertical scaler 220 and pixel data 222 into FIFO 226. The present invention also provides clock 278 to clock pixel data 228 out of FIFO 226 and output 232 out of modulator/timing generator 230. By providing clocks 276 and 278, respectively, at 75 MHz and 50 MHz, the present invention provides support for the conversion of a high resolution video format, such as the 1024×768 resolution SVGA video format, into a low resolution video format, such as NTSC video format.

Referring to the above example, approximately 3748 input clock cycles are required for inputting SVGA video format 1024×768 resolution pixel data, assuming the external source supplying the input data can provide consecutive lines with no intervening breaks, called horizontal blanking. If there are intervening breaks in the lines being supplied by the external source, even more clock cycles would be required per input line. Also as stated above, approximately 2472 output clock cycles are required per line of pixel data in NTSC video format. The present embodiment of the invention's video encoder provides clock 276, at 75 MHz to clock a line of pixel data into FIFO 226. During a duration of time equal to 3.66 input lines, a line of pixel data is clocked out of FIFO 226 by clock 278, at 50 MHz. As such, the time that it takes to input the required SVGA video format 1024×768 resolution pixel data is approximately the same as the time that it takes to output all of the incoming pixel data into the required number of active lines per field in the NTSC video format.

The present embodiment of the invention's video encoder 202 has the capability of inputting pixel data at one clock frequency and converting the pixel data to another video format by using a different clock frequency in the conversion process. This capability allows the invention's video encoder to overcome the disadvantages of the related art described in the background art section by being able to a convert, for example, higher resolution SVGA video format 1024×768 pixel data into lower resolution video format pixel data, such as NTSC.

By providing horizontal scaling of input pixel data through the operation of two different clock frequencies, the present embodiment of the invention overcomes the prior disadvantages of either foregoing support for higher video format resolutions, such as SVGA 1024×768, or forcing the device providing the input pixel data to scale higher resolution pixel data down to a lower resolution, such as VGA 640×480.

While certain embodiments of the invention are specifically illustrated in the drawings and are specifically described herein, it is apparent to those of ordinary skill in the art that the specific embodiment described herein may be modified without departing from the inventive concepts described. For example, the frequencies of either clock 276 or clock 278, or both clock 276 and clock 278 may be changed to accommodate video formats with various resolutions of pixel data. Thus, a person of ordinary skill in the art can apply the principles of the invention, as defined by the claims appended herein, beyond the embodiments of the invention specifically discussed herein.

Thus, a multi-frequency video encoder for high resolution support has been described.

1. A video encoder comprising:
a vertical scaler, wherein said vertical scaler receives a first plurality of video lines at a first frequency and outputs a second plurality of video lines at said first frequency;
a FIFO, wherein said FIFO receives said second plurality of video lines at said first frequency from said vertical scaler, said FIFO outputting said second plurality of video lines at a second frequency.

2. The video encoder of claim 1 wherein said second plurality of video lines are in a first video format.

3. The video encoder of claim 2 further comprising a modulator/timing generator, wherein said modulator/timing generator receives said second plurality of video lines from said FIFO in said first video format, and said modulator/timing generator converts said first video format into a second video format.

4. The video encoder of claim 3 wherein said first video format is selected from the group consisting of VGA and SVGA.

5. The video encoder of claim 3 wherein said second video format is selected from the group consisting of NTSC, PAL, SECAM, and SCART.

6. The video encoder of claim 3 wherein said first video format is SVGA and said second video format is NTSC.

7. The video encoder of claim 1 wherein said first frequency is an integer ratio of said second frequency.

8. The video encoder of claim 1 wherein said first frequency is a non-integer ratio of said second frequency.

9. The video encoder of claim 1 wherein a first clock has said first frequency and a second clock has said second frequency, and wherein said first clock and said second clock are synchronous.

10. The video encoder of claim 1 wherein a first clock has said first frequency and a second clock has said second frequency, and wherein said first clock and said second clock are asynchronous.

11. A method comprising steps of.
receiving by a vertical scaler a first plurality of video lines at a first frequency;
scaling in said vertical scaler said first plurality of video lines at said first frequency into a second plurality of video lines at said first frequency;
outputting by said vertical scaler said second plurality of video lines at said first frequency;
receiving by a FIFO said second plurality of video lines at said first frequency;
outputting by said FIFO said second plurality of video lines at a second frequency.

12. The method of claim 1 1 further comprising steps of:
receiving by a modulator/timing generator said second plurality of video lines in a first video format;
converting in said modulator/timing generator said second plurality of video lines from said first video format into a second video format.

13. The method of claim 12 wherein said first video format is selected from the group consisting of VGA and SVGA.

14. The method of claim 12 wherein said second video format is selected from the group consisting of NTSC, PAL, SECAM, and SCART.

15. The method of claim 12 wherein said first video format is SVGA and said second video format is NTSC.

16. The method of claim 11 wherein said first frequency is an integer ratio of said second frequency.

17. The method of claim 11 wherein said first frequency is a non-integer ratio of said second frequency.

18. The method of claim 11 wherein a first clock has said first frequency and a second clock has said second frequency, and wherein said first clock and said second clock are synchronous.

19. The method of claim 11 wherein a first clock has said first frequency and a second clock has said second frequency, and wherein said first clock and said second clock are asynchronous.

20. A system comprising:
a multi-frequency clock generator, wherein said multi-frequency clock generator outputs a first clock at a first frequency and a second clock at a second frequency;
a vertical scaler, wherein said vertical scaler receives said first clock at said first frequency from said multi-frequency clock generator, and wherein said vertical scaler receives a first plurality of video lines at said first frequency and outputs a second plurality of video lines at said first frequency;
a FIFO, wherein said FIFO receives said first clock at said first frequency and said second clock at said second frequency from said multi-frequency clock generator, and wherein said FIFO receives said second plurality of video lines at said first frequency from said vertical scaler, and wherein said FIFO outputs said second plurality of video lines at said second frequency.

21. The system of claim 20 wherein said second plurality of video lines are in a first video format.

22. The system of claim 21 further comprising a modulator/timing generator, wherein said modulator/timing generator receives said second clock at said second frequency from said multi-frequency clock generator, wherein said modulator/timing generator receives said second plurality of video lines from said FIFO in said first video format, and said modulator/timing generator converts said first video format into a second video format.

23. The system of claim 22 wherein said first video format is selected from the group consisting of VGA and SVGA.

24. The system of claim 22 wherein said second video format is selected from the group consisting of NTSC, PAL, SECAM, and SCART.

25. The system of claim 22 wherein said first video format is SVGA and said second video format is NTSC.

26. The system of claim 20 wherein said first frequency is an integer ratio of said second frequency.

27. The system of claim 20 wherein said first frequency is a non-integer ratio of said second frequency.

28. The system of claim 20 wherein said first clock and said second clock are synchronous.

29. The system of claim 20 wherein said first clock and said second clock are asynchronous.
